(19) United States
(12) Patent Application Publication
(10) Pub. No.: US 2021/0076658 A1
(43) Pub. Date: Mar. 18, 2021

(54) Insect Bait

(71) Applicant: Semya, Inc., Spokane, WA (US)

(72) Inventor: Sergey Stefoglo, Spokane, WA (US)

(21) Appl. No.: 16/569,256

(22) Filed: Sep. 12, 2019

(51) Int. Cl. A01M 1/10; A01M 1/02

(52) U.S. Cl. CPC A01M 1/106; A23L 17/00; A01M 2200/012; A01M 1/02

(57) ABSTRACT

An insect-trap olfactory bait is formed by processing fish (for example, by using a salt) and then aging the processed fish. The processing can then be reversed at least in part (for example, by rinsing away some salt) following which the resultant fish parts are placed in contact with an alcohol. Solid remnants of the resultant fish parts are later separated from the alcohol to thus provide an olfactory fish extract infused liquid filtrate. These teachings will accommodate, during at least a portion of such a process, dehydrating the fish parts. By another approach, in lieu of the foregoing or in combination therewith, these teachings will accommodate, prior to separating solid remnants of the resultant fish part from the alcohol, comminuting the fish parts to thereby reduce the overall average size and density of the solid fish material.

### TECHNICAL FIELD

These teachings relate generally to wasp attractants and more particularly to insect attractants suitable for use as bait in an insect trap.

### BACKGROUND

Insects of the order Hymenoptera have four transparent wings and the females typically have a stinger. While some members of this order are useful (such as bees), others are often viewed as being a nuisance or even dangerous (such as wasps).

It is known to employ traps to capture wasps. Wasp traps are typically baited in some fashion to thereby attract wasps into the trap. A variety of baits have been employed or studied including various meats (including beef, poultry, and fish), pheromones, and so forth. Some prior art efforts suggest that bee-based baits (such as pollen and honey odors as well as various pheromones such as the honeybee aggregation pheromone geraniol as pheromones produced by honeybee larvae and honeybee queens) can be highly effective and provide superior luring results as compared to such other baits.

The effectiveness of bee-based baits may not be surprising given that wasps are known to attack bees and especially beehives. Though worker bees wield a stinger, wasps usually have a size advantage and can sting multiple times as compared to a bee. As a result, wasps can and do overwhelm the natural defenses of honeybees. Such attacks can be devastating and result in severe damage to a hive's population.

Wasp traps using any of a variety of baits are sometimes deployed near beehives to try and avoid such attacks. Unfortunately, such efforts can be futile as the wasps can prefer the lure presented by the bees themselves in comparison to the baits used in the traps.

### BRIEF DESCRIPTION OF THE DRAWINGS

The above needs are at least partially met through provision of the insect bait described in the following detailed description, particularly when studied in conjunction with the drawings, wherein:

FIG. 1 comprises a flow diagram as configured in accordance with various embodiments of these teachings; and

FIGS. 2-4 comprise GC/MS chromatograms of both blanks and embodiments of the present teachings.

Elements in the figures may be illustrated for simplicity and clarity and have not necessarily been drawn to include all possible variations. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, these various embodiments yield an insect-trap olfactory bait that is highly effective at luring wasps, even when deployed in close proximity to beehives.

By one approach, these teachings provide a method of forming an insect-trap olfactory bait that includes providing at least a part of at least one fish to thereby provide at least one fish part. This approach provides for processing the at least one fish part by adding at least one non-fish augmenting material to thereby provide at least one processed fish part. For example, processing can include adding a salt such as sodium chloride to at least one fish part to thereby provide at least one processed fish part. In some approaches, a salt can be added in selected amounts relative to the total mass of the at least one fish part. For example, one teaspoon of sodium chloride can be added per pound of fish. At least one processed fish part can then be aged to provide an aged processed fish part following which these teachings provide for removing at least a substantial portion of the processing (for example, by removing the aforementioned augmented material) from the aged processed fish part to thereby provide a resultant fish part. Without intending to be bound by any particular theory, it is thought that addition of salt to at least one fish part provides augmented conditions for microbe growth and production of chemical compounds during subsequent aging of the at least one processed fish part.

By this approach, the method then provides for contacting the resultant fish part with at least one carrier liquid. Useful carrier liquids comprise any of one or more alcohols, water, an aqueous solution, one or more oils, an emulsion, and so forth and combinations thereof. In some approaches, a carrier liquid can include any one or more of monohydric and polyhydric alcohols in an aqueous solution. Examples of useful alcohols include ethanol, propanols such as isopropanol, butanols such as n-butanol, polyhydric alcohols such as diols, triols, and so forth, and combinations thereof. At least some solid remnants of the resultant fish part are separated from the carrier liquid to thus provide an olfactory fish extract infused liquid filtrate.

By one approach these teachings will accommodate, during at least a portion of such a process, dehydrating the fish part or parts. By another approach, in lieu of the foregoing or in combination therewith, these teachings will accommodate, prior to separating at least some solid remnants of the resultant fish part from the carrier liquid, comminuting the fish part or parts to thereby reduce the overall average size and density of the solid fish material.

By one approach these teachings will accommodate packaging the olfactory fish extract infused liquid filtrate in, for example, a sealed container to facilitate subsequent distribution and storage.

The resultant olfactory fish extract infused liquid filtrate has proven highly effective in attracting wasps, even when deployed very close to active beehives. Such results strongly evidence that this bait is more attractive to at least some wasps than the sights, sounds, and scents of a beehive. Accordingly, this resultant insect-trap olfactory bait is highly effective at protecting beehives from many predatory wasps.

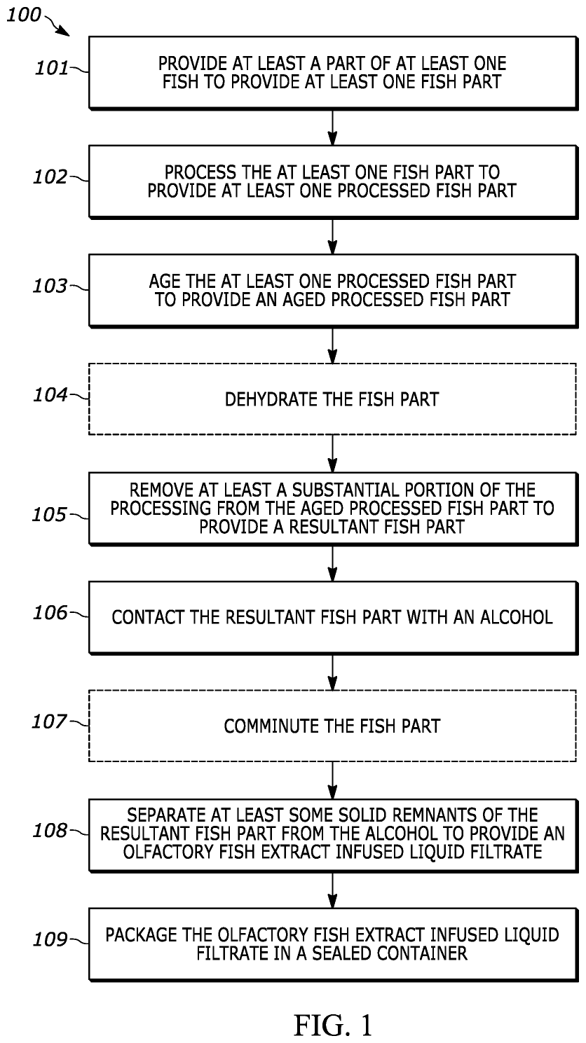

These and other benefits may become clearer upon making a thorough review and study of the following detailed description. Referring now to the drawings, and in particular to FIG. 1, an illustrative embodiment of a process 100 that is compatible with many of these teachings will now be presented.

At block 101, this process 100 provides at least a part of at least one fish to thereby provide at least one fish part. Generally speaking, these teachings are not overly sensitive to the selection of any particular fish (including both saltwater fish and freshwater fish). Also, and again generally speaking, these teachings are not overly sensitive as to whether the fish part is meat only or includes other fish parts including various organs and parts of the fish's digestive system. At this point in the process, the at least one fish part may comprise, for example, the entire fish, one half of a fish (or some other fraction of a fish), or a plurality of the same or different types of fish (or parts from a plurality of the same or different types of fish). Fresh fish can serve in these regards but freshness is not a requirement. Generally speaking, the utilized fish should not be severely decomposed. The fish can be at any of a wide range of ordinary ambient or refrigerated temperatures, but if frozen, should be thawed before use. Generally speaking, the utilized fish should be raw or at least no more than very lightly cooked.

At block 102, this process 100 then provides for processing, e.g. adding at least one augmenting material to, the at least one fish part to provide at least one processed fish part. By one approach this processing comprises seasoning and/or preserving the at least one fish part. (As used herein, “preserving” does not necessarily mean completing a preservation process but can include one or more steps ordinarily taken to preserve fish, such as adding salt to the fish; and “seasoning” can include but is not limited to enhancement or modification of a fish part with respect to conditions for subsequent ageing.) As one illustrative example in these regards, this activity can comprise processing the at least one fish part using, at least in part, a salt (such as, but not limited to, sodium chloride).

Such processing can comprise using only salt or salt in conjunction with one or more other augmenting or inert materials. When using a mixture, the salt can comprise a majority component of the mixture, constituting, for example, at least 55 percent of the mixture, 75 percent of the mixture, 85 percent of the mixture, 90 percent of the mixture, 95 percent of the mixture, 99 percent of the mixture, or some other proportion of choice. By one approach the “salt” can itself comprise a mixture of salts, such as a mixture of sodium chloride and potassium chloride.

At block 103, this process 100 then provides for aging the at least one processed fish part to thereby provide an aged processed fish part. This aging can occur at any of a variety of temperatures ranging from 0° C. to 40° C. By one approach the temperature is maintained relatively stable (such as within a range of plus or minus 1° C. or 2° C. of a target temperature) for the substantial duration of the aging process. By another approach the temperature can fluctuate within, for example, some ordinary ambient range of room or outdoor temperatures, either according to some predetermined schedule or simply as the ambient temperature itself changes over time. By one approach, this aging process takes place within a range of time, such as for at least eight hours and for no more than three weeks or for at least 12 hours to no more than two weeks.

As suggested at optional block 104, this process 100 can include dehydrating the fish part. This dehydrating (or at least a majority portion of any dehydration) can occur subsequent to the processing steps described above and prior to commencing the next activity described at block 106. Accordingly, by one approach, the fish part(s) can be dehydrated before, during, and/or after the above-described aging process. The dehydration can serve to remove, for example, up to 50 percent of any moisture from the fish part(s) or any other desired percentage (such as, for example, up to 60 percent, 70 percent, 80 percent, 90 percent, 95 percent, and even 99 or 100 percent). These teachings are not particularly reliant upon any specific dehydration regimen. The fish part(s) can be dehydrated, for example, via sun drying, air drying, or forced air drying, to note but a few examples.

At block 105 this process 100 provides for removing at least a substantial portion of the processing (i.e., at least one augmenting material as described above) from the aged processed fish part to provide a resultant fish part. For example, when salt(s) are added to fish part(s), this activity can comprise removing part or all of the salt(s) from the fish part(s). By one approach this comprises rinsing the aged processed fish part using, at least in part, water. Ordinary tap water or fresh water from a well can serve well in these regards. The water itself can have a temperature ranging from, for example, 15° C. to 40° C. as desired. The amount of water utilized and the amount of time taken to accomplish this step can vary as desired and also as a function of the relative size or density of the fish part(s) being rinsed. In other aspects, one or more liquids other than water can be used to rinse an aged processed fish part so long as such liquids function to remove at least a substantial portion of the at least one augmenting material from the aged processed fish part so as to provide a resultant fish part.

If desired, the rinsed, resultant fish part(s) can be dehydrated as described above. By one approach this can comprise a first time that the fish part(s) is dehydrated. By another approach, this can be at least a second time that the fish part(s) is dehydrated.

The resultant fish part(s) to this point in the process 100 can, in fact, serve as a useful insect-trap olfactory bait having a pungent unpleasant smell.

While the process described up to this point can provide an effective insect-trap olfactory bait in and of itself, the applicant has determined that additional processing can yield an even more effective attractant.

Additional processing can comprise contacting a resultant fish part with a carrier liquid. With that in mind, at block 106, this process 100 can include contacting the resultant fish part with an alcohol. In an aspect, this can comprise submersing at least a part of the resultant fish part in the alcohol. In some cases, the alcohol can be an ethanol-containing liquor having an ethanol content ranging from 20 to 180 proof, with a 80 proof liquor providing very useful results.

Generally, fish part(s) can be left to soak in a carrier liquid such as alcohol for as little as a few hours (such as two or four hours) and for as long as several years. The applicant has determined that good results can be obtained when leaving the fish part(s) in a carrier liquid such as alcohol for approximately one week. The applicant has also determined that better results may occur when occasionally mixing the fish/carrier liquid during this time.

By one optional approach, and as shown at optional block 107, this process 100 will accommodate comminuting the fish part(s) to thereby provide smaller fish parts. This activity can comprise, for example, grinding the fish part(s) into smaller fish part(s) of a desired size. This comminution can occur prior to contacting the fish part(s) with a carrier liquid such as alcohol, during the carrier liquid contacting step, or subsequent to the carrier liquid contacting step. The applicant has determined that good results can be achieved by comminuting the fish part(s) prior to contacting the fish part(s) with the carrier liquid.

At block 108, the process 100 provides for separating at least some solid remnants of the resultant fish part(s) from the carrier liquid to provide an olfactory fish extract infused liquid filtrate. By one approach this separation activity employs one or more filters. As one example in these regards, a single, double, or triple layer of cheesecloth can serve well in these regards. By one approach this separation activity can also include an application of pressure (in order to help move the filtrate through the filter material, for example). In one case the applicant employed 20 pounds of pressure to good effect. The amount of pressure applied can be varied as desired to suit the needs and circumstances of a given application setting.

The resultant olfactory fish extract infused liquid filtrate constitutes the carrier liquid, such as alcohol, and various liquids/oils obtained from the fish. By one approach, as shown at optional step 109, this process 100 will accommodate packaging the olfactory fish extract infused liquid filtrate in a sealed container of choice (such as a glass container or a plastic packet). The olfactory fish extract infused liquid filtrate can be used as-is as an insect, e.g. wasp, trap bait. Or, if desired, it may be acceptable to dilute the olfactory fish extract infused liquid filtrate with, for example, an additional carrier liquid, e.g. alcohol.

By one approach, small bits of the fish from any of the described stages of the process 100 can be included in the olfactory fish extract infused liquid filtrate if desired. As one approach in these regards, dehydrated fish bits could be packaged in porous fabric pouches that are then placed in the final packaging of the olfactory fish extract infused liquid filtrate. So configured, the olfactory fish extract infused liquid filtrate may be further infused with compounds from the marinated fish bits during storage and/or distribution.

The ageing process can produce a number of compounds such as peptides, amino acids, ammonia, fatty acids, organic acids, alcohols, esters, ketones, aldehydes, aromatics, etc. For example, compounds present in a resultant fish part produced according to the present teachings can include isovaleric aldehydes and acids such as 3-methyl butanal, 2-methyl butanal, 3-methyl butanoic acid, 2-methyl butanoic acid, etc., aldehydes such as hexanal etc., diols such as ethylene glycol adipate etc., aromatic compounds like aromatic alcohols such as phenol and 4-sec-Butyl-2,6-di-tert-butylphenol (Isonox 132), etc., and aromatic heterocyclics such as 3-ethyl-2,5-dimethyl pyrazine, 2,6-diethyl pyrazine, and indole, etc., acetates such as Beta-terpinyl acetate, etc.

Without intending to be bound to any particular theory, it is thought that contacting a resulting fish part with a carrier liquid such as one or more alcohols produces additional chemical species not present in a resultant fish part before such treatment. For example, an olfactory fish extract infused liquid filtrate can include alcohols such as ethanol, propanols such as isopropanol, butanols such as n-butanol, polyhydric alcohols such as diols, triols, etc., lactic acid derivatives such as lactic amide, etc., amino acid derivatives such as valeric acid hydrazide, etc., aromatic compounds such as xylene, e.g. p-xylene, toluene, methyl toluene, aromatic heterocyclics, etc., fatty acid esters such as hexanoic acid, ethyl ester, heptanoic acid, ethyl ester, butanoic acid, ethyl ester, undecanoic acid, ethyl ester, etc., hydrocarbons such as octane, and optionally compounds present in a resultant fish part.

### EXAMPLES

### Example 1

Relevant compounds found in the resultant fish part(s) to this point in the process 100 are shown in TABLE 1.

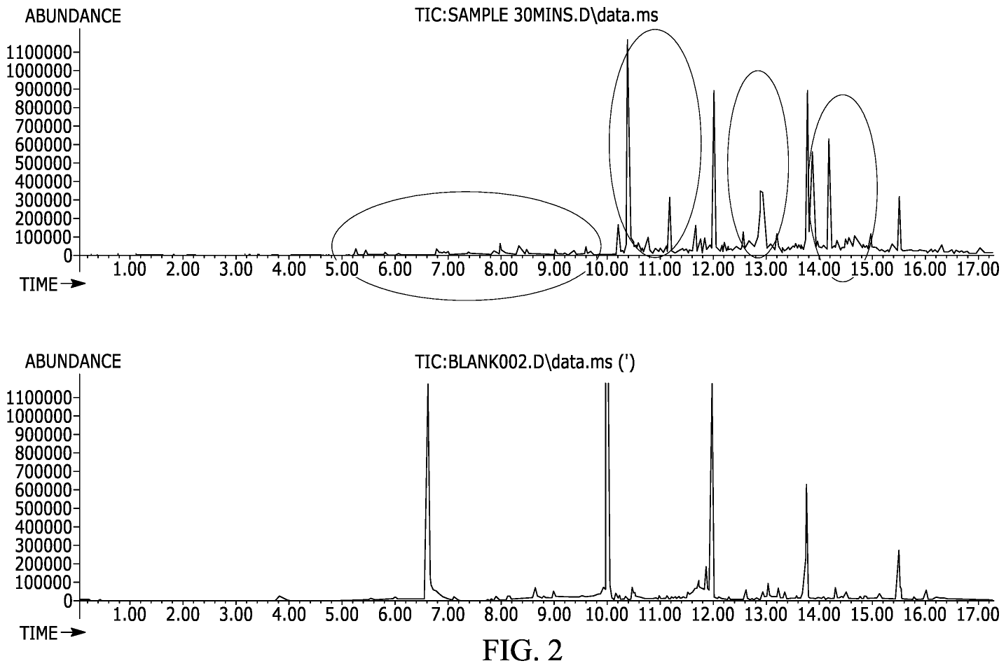

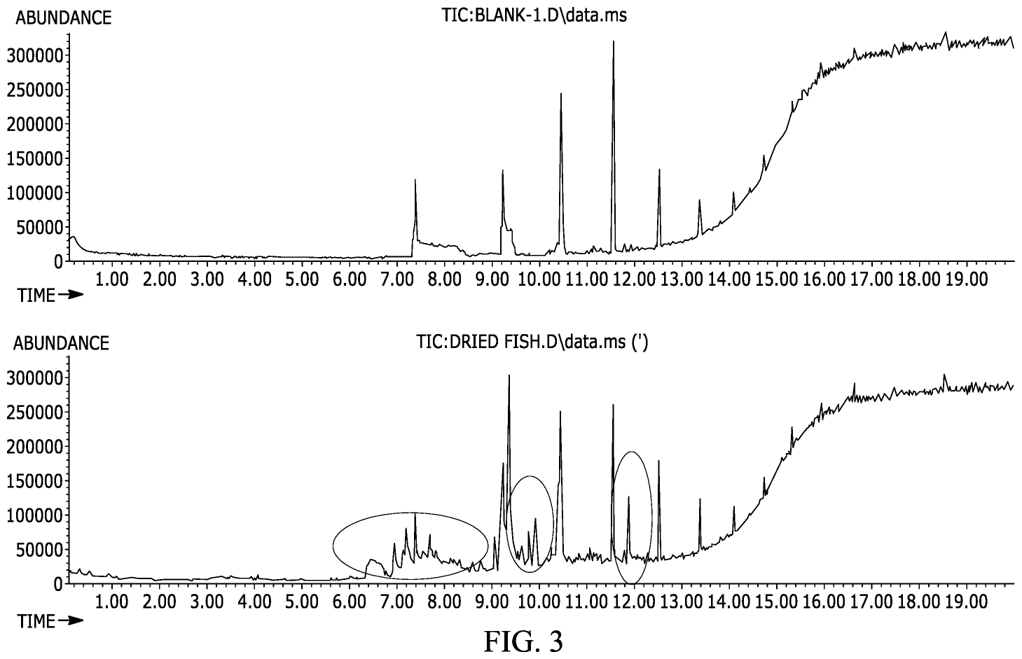

Two Gas Chromatography/Mass Spectroscopy (GC/MS) analyses were performed to capture volatile compounds from samples of resultant fish parts prepared according to this example. FIG. 2 shows GC/MS chromatograms of a tested resultant fish part and a blank at temperature ramp of 30-200° C. and 30 minutes sample testing. FIG. 3 shows GC/MS chromatograms of a blank and a tested resultant fish part at a temperature ramp 50-300° C. and 15 minutes sample testing.

The samples were tested using a GC Agilent 6890N, a DB-5 MS column (30 m×0.25 mm×1.0 μm), a splitless inlet @ 200° C. and 280° C., manual injection, a gas flow rate 1.2 ml/min, mass of m/z 50-800, and the following ramps:

| Temperature, ° C. | Rate, ° C./min | Time (min) |
|---|---|---|
| | 30 | 3 |
| 15 | 200 | 3 |

*For 30 mins sample prep

| Temperature, ° C. | Rate, ° C./min | Time (min) |
|---|---|---|
| | 50 | 5 |
| 25 | 300 | 5 |

*For 15 mins sample prep

Samples were prepared by adding 1.2552 g of the dried fish into a GC Headspace vial and then placing the vials an oven (65° C.) for 15 minutes and 30 minutes with a solid phase micro-extraction (SPME) needle inserted into the dried fish. The SPME fiber was directly analyzed using GC-MS. Table 1 includes a summary of compounds found by the tests.

TABLE 1

| Compound Match | Probability (%) | Intensity | Compound Type | Odor Type |
|---|---|---|---|---|
| 3-methyl butanal | 71% | Low | Isovaleric Aldehyde | Irritating |
| 2-methyl butanal | 52% | Low | Isovaleric Aldehyde | Irritating |
| Hexanal | 47% | Low | Aldehyde | — |
| 3-methyl butanoic acid | 82% | Medium | Isovaleric Acid | Rancid |
| 2-methyl butanoic acid | 59% | Medium | Isovaleric Acid | Rancid |
| Ethylene glycol, adipate | 53% | High | Glycol | — |
| Phenol | 68% | High | Aromatic alcohol | sweet tarry |
| Isonox 132 (Phenol based) | 82% | High | Aromatic alcohol | sweet tarry |
| Beta-terpinyl acetate | 25% | High | Acetate | — |
| 3-ethyl-2,5-dimethyl pyrazine | 39% | Low | Aromatic heterocyclic | Nutty roasted |
| 2,6-diethyl pyrazine | 30% | Low | Aromatic heterocyclic | Nutty roasted |
| Indole | 54% | High | Aromatic heterocyclic | Fecal odor |

The above table describes the various compounds, compound types, and general corresponding odor types and intensities for the compounds. The majority of the volatile compounds of the resultant odor are butanal, butanoic acid, phenol, indole, and pyrazine.

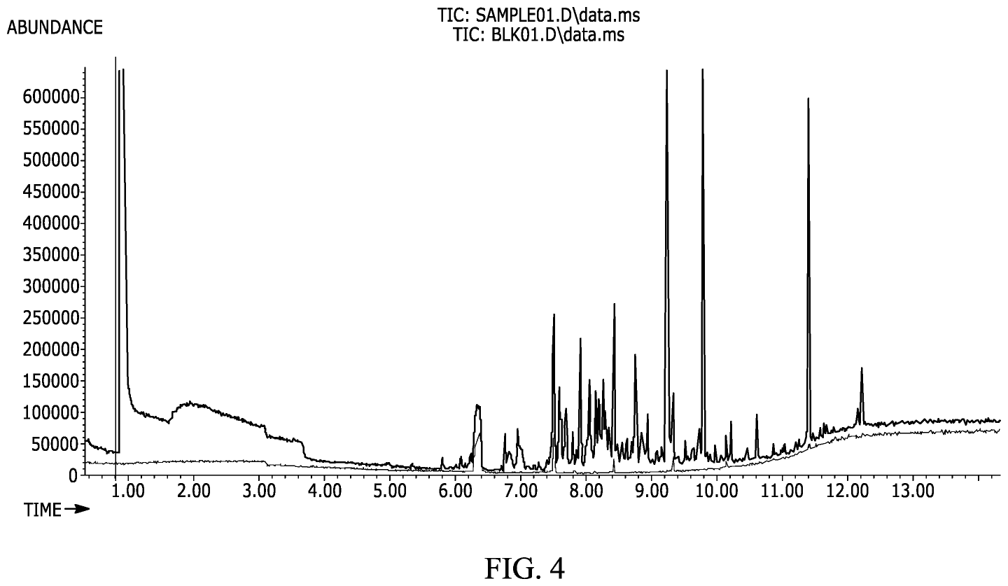

A GC/MS analysis was performed to capture volatile compounds from a sample of the olfactory fish extract infused liquid filtrate prepared according to this example. FIG. 4 shows GC/MS chromatograms of a tested filtrate and a blank.

The sample was tested using a GC Agilent 6890N, a DB-5 MS column (30 m×0.25 mm×1.0 μm), a splitless inlet @ 250° C., manual injection, a gas flow rate 1.0 ml/min, mass of m/z 50-800, and the following ramp:

| Rate, ° C./min | Temperature, ° C. | Time (min) |
|---|---|---|
| | 30 | 3 |
| 30 | 280 | 3 |

The sample was prepared by adding 1.8822 g of the olfactory fish extract infused liquid filtrate into a GC Headspace vial and then placing the vial in an oven (60° C.) for 30 minutes with a solid phase micro-extraction (SPME) needle inserted into the liquid. The SPME fiber was directly analyzed using GC-MS. Table 2 includes a summary of compounds found by the test.

TABLE 2

| Compound Match | Probability (%) | Intensity | Compound Type | Odor Type |
|---|---|---|---|---|
| Ethanol | 94.5% | High | Solvent | Pungent |
| Lactic amide | 75.0% | Medium | Lactic acid derivative | — |
| Toluene | 42.8% | Low | Solvent | Pungent |
| Valeric acid hydrazide | 12.0% | Low | Amino acid derivative | Cheesy |
| Octane | 16.0% | Low | Solvent | — |
| p-xylene | 45.3% | Medium | Solvent | Woody |
| Hexanoic acid, ethyl ester | 33.4% | High | Fatty Acid ester | Fruity |
| Methyl-Toluene | 16.0% | Low | Solvent | Pungent |
| Beta-terpinyl acetate | 12.0% | Medium | Acetate | sweet tarry |
| Heptanoic acid, ethyl ester | 43.3% | High | Fatty Acid ester | Fruity |
| Butanoic acid, heptyl ester | 70.0% | High | Fatty Acid ester | Acid, fruity |
| Undecanoic acid, ethyl ester | 29.0% | High | Aromatic heterocyclic | cheesy |

The majority of the volatile compounds of the odor emanating from the olfactory fish extract infused liquid filtrate are ethanol, butanoic acid, and fatty acid esters.

Those skilled in the art will understand and recognize that a similar or identical olfactory liquid could be synthetically formed by combining the identified compounds into solution with one another. The relative proportions of each compound could be varied as desired. If desired, other compounds could also be added to such a solution.

These teachings would also accommodate adding one or more of these pure compounds to an olfactory fish extract infused liquid filtrate formed using the described process 100.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

We claim:

1. A method of forming an insect-trap olfactory bait, comprising:
providing at least a part of at least one fish to provide at least one fish part;
adding at least one augmenting material to the at least one fish part to provide at least one processed fish part;
aging the at least one processed fish part to provide an aged processed fish part;
removing at least a substantial portion of the at least one augmenting material from the aged processed fish part to provide a resultant fish part;
contacting the resultant fish part with carrier liquid;
separating at least some solid remnants of the resultant fish part from the carrier liquid to provide an olfactory fish extract infused liquid filtrate.

2. The method of claim 1 wherein the insect comprises a Hymenoptra member.

3. The method of claim 2 wherein the insect comprises a wasp.

4. The method of claim 1 wherein the at least one augmenting material comprises, at least in part, a salt.

5. The method of claim 4 wherein the salt comprises, at least in part, sodium chloride.

6. The method of claim 5 wherein aging the at least one processed fish part comprises aging the at least one processed fish part for at least eight hours.

7. The method of claim 5 wherein aging the at least one processed fish part comprises aging the at least one processed fish part for no more than three weeks.

8. The method of claim 1 wherein aging the at least one processed fish part comprises aging the at least one processed fish part at a temperature ranging from 0 degrees C. to 40 degrees C.

9. The method of claim 1 wherein removing at least a substantial portion of the at least one augmenting material from the aged processed fish part comprises rinsing the aged processed fish part.

10. The method of claim 9 wherein rinsing the aged processed fish part comprises rinsing the aged processed fish part using, at least in part, water.

11. The method of claim 10 wherein the water has a temperature ranging from 15 degrees C. to 40 degrees C.

12. The method of claim 1 wherein contacting the resultant fish part with an alcohol comprises submersing at least a part of the resultant fish part in the alcohol.

13. The method of claim 1 wherein separating at least some solid remnants of the resultant fish part from the alcohol comprises using filtration.

14. The method of claim 13 wherein separating at least some solid remnants of the resultant fish part from the alcohol further comprises using an application of pressure.

15. The method of claim 1 further comprising, subsequent to adding the at least one augmenting material to the at least one fish part and prior to contacting the resultant fish part with an alcohol, dehydrating the fish part.

16. The method of claim 1 further comprising, prior to separating at least some solid remnants of the resultant fish part from the alcohol, comminuting the fish part.

17. The method of claim 1 further comprising:
packaging the olfactory fish extract infused liquid filtrate in a sealed container.
